(19) United States
(12) Patent Application Publication
(10) Pub. No.: US 2013/0043115 A1
(43) Pub. Date: Feb. 21, 2013

(54) KEYBOARD MODULE

(71) Applicants: Fei-Lin Yang, Taipei (TW); Chao-Ming Chu, Taipei (TW); Yang-Po Chiu, Taipei (TW); Shin-Min Lee, Taipei (TW); Chiu-Lang Huang, Taipei (TW)

(72) Inventors: Fei-Lin Yang, Taipei (TW); Chao-Ming Chu, Taipei (TW); Yang-Po Chiu, Taipei (TW); Shin-Min Lee, Taipei (TW); Chiu-Lang Huang, Taipei (TW)

(21) Appl. No.: 13/587,638

(22) Filed: Aug. 16, 2012

Related U.S. Application Data
(60) Provisional application No. 61/525,021, filed on Aug. 18, 2011.

(51) Int. Cl. H01H 13/76

(52) U.S. Cl. 200/5 A

(57) ABSTRACT

A keyboard module includes a key unit, a fixed unit and a cover layer. The key unit includes a plurality of key structures. The fixed unit includes a plurality of position limiting structures, and the position limiting structures are fixed to the corresponding key structures, respectively. The cover layer covers and connects to the key unit and the fixed unit.

### CROSS REFERENCE TO RELATED APPLICATIONS

The non-provisional patent application claims priority to U.S. provisional patent application with Ser. No. 61/525,021 filed on Aug. 18, 2011. This and all other extrinsic materials discussed herein are incorporated by reference in their entirety.

### BACKGROUND OF THE INVENTION

1. Field of Invention

The present disclosure relates to a keyboard module.

2. Related Art

The conventional keyboard is composed of a plurality of keys made of plastic by injection molding, and obvious gaps exist between keycaps, so that dusts, particles or liquid may enter the keyboard through the gaps. It is not easy to clean these entered dusts, particles or liquid which may cause the damage of the keyboard. Furthermore, the space under keyboard of the laptop computer is usually configured to many important electronic components, therefore, the entered dusts, particles or liquid may cause damage or affect the operation of the laptop computer. Accordingly, a flexible protector is used to cover the keycaps and the gaps for dustproof and waterproof. However, the flexible protector can not be tightly attached on the keyboard, which means gaps still exist between the edge of the flexible protector and the keyboard, so that the dusts, particles and liquid may still enter the keyboard through the spaces.

Otherwise, some illuminated keyboards are provided for the dark environment. Most of the illuminated keyboards are configured with a light source (e.g. LED light source) under the keycaps of the keyboard. The keyboard may include some holes not only to dispose the keycaps, but also allow the light to pass through. However, since the size of the hole may be larger than the size of the keycap, light leakage may occur through the lateral sides of the keycap. This causes some problems such as power loss, light interference, and bad appearance.

### SUMMARY OF THE INVENTION

The disclosure provides a keyboard module. The keyboard module includes a key unit, a fixed unit and a cover layer. The key unit includes a plurality of key structures. The fixed unit includes a plurality of position limiting structures which are respectively fixed to the key structures. The cover layer covers and connects to the key unit and the fixed unit.

As mentioned above, the keyboard module is configured with a cover layer for covering and connecting the key units, so that it can make users have comfortable feeling of touch and provide block the gaps between the keycaps of the key unit, and further to prevent the objects or liquid from entering the keyboard module, and avoid light leakage. Moreover, the cover layer is fixed to the surface of the position limiting structure of the fixed unit or the key structure of the key unit rather than adhered entirely or no joining relation. Thus, when the keyboard module is pressed, it can prevent the protruding of the cover layer around the key unit, which causes undesired appearance, and it is unnecessary to apply extra force to press the key. Besides, the keyboard module is especially suitable for the laptop computer for using the cover layer to cover or encapsulate the casing so as to protect the internal components from the damage of external objects or liquid.

### BRIEF DESCRIPTION OF THE DRAWINGS

FIG. 1 is a schematic diagram showing a keyboard module according to a preferred embodiment of the disclosure, wherein the keyboard module is disposed on a casing;

FIG. 2 is an exploded view of the keyboard module according to the preferred embodiment of the disclosure;

FIG. 3A is a cross-sectional view of the keyboard module according to the preferred embodiment of the disclosure;

FIG. 3B is a schematic diagram showing a key unit of FIG. 3A, which is pressed;

FIG. 3C is a schematic diagram showing another aspect of the keyboard module of FIG. 3A;

FIG. 3D is a schematic diagram showing another aspect of the keyboard module of FIG. 3A;

FIG. 4A is a cross-sectional view of a keyboard module according to another preferred embodiment of the disclosure; and

FIG. 4B is a schematic diagram showing a key unit of FIG. 4A, which is pressed.

### DETAILED DESCRIPTION OF THE INVENTION

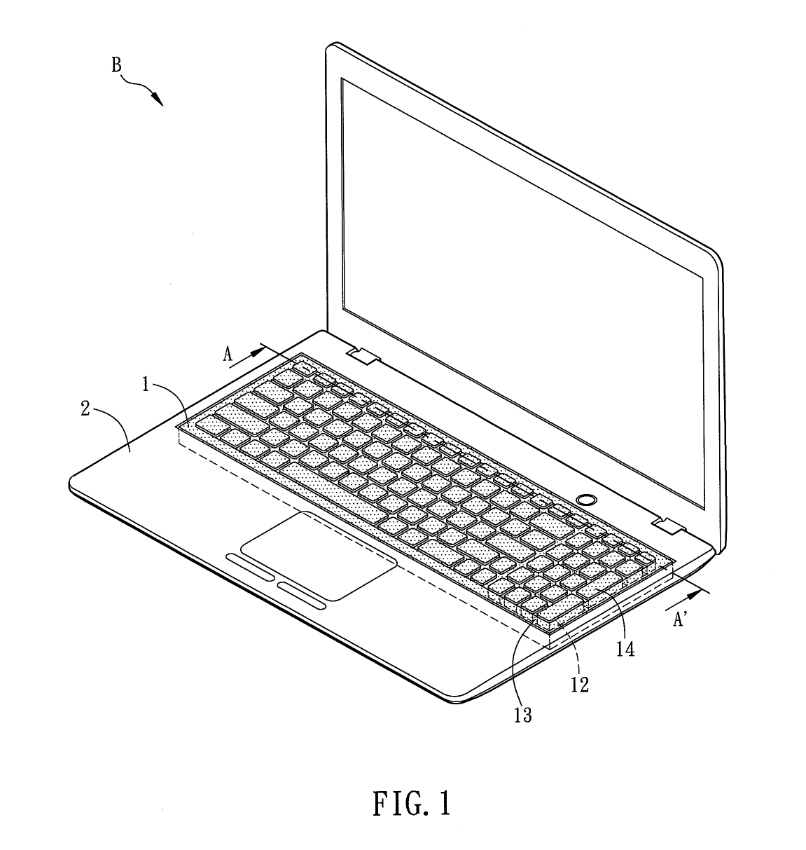

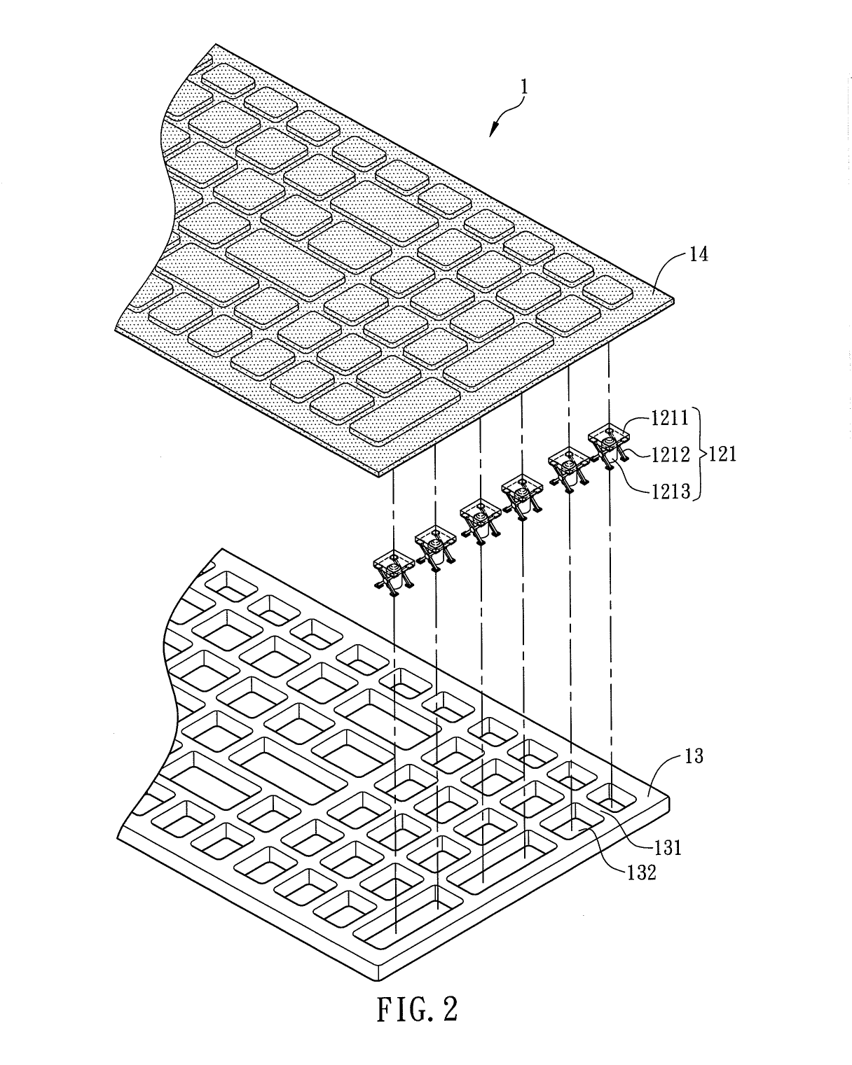

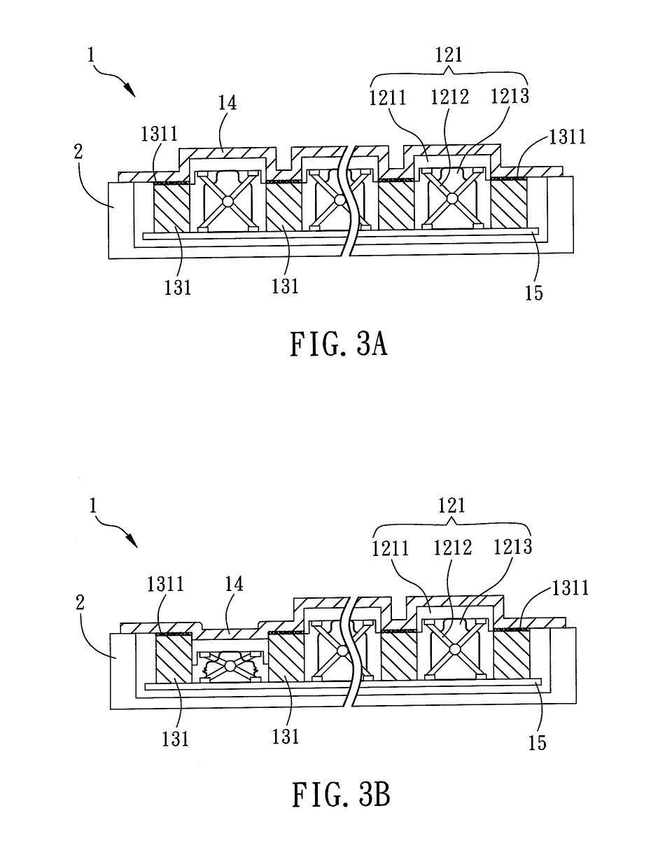

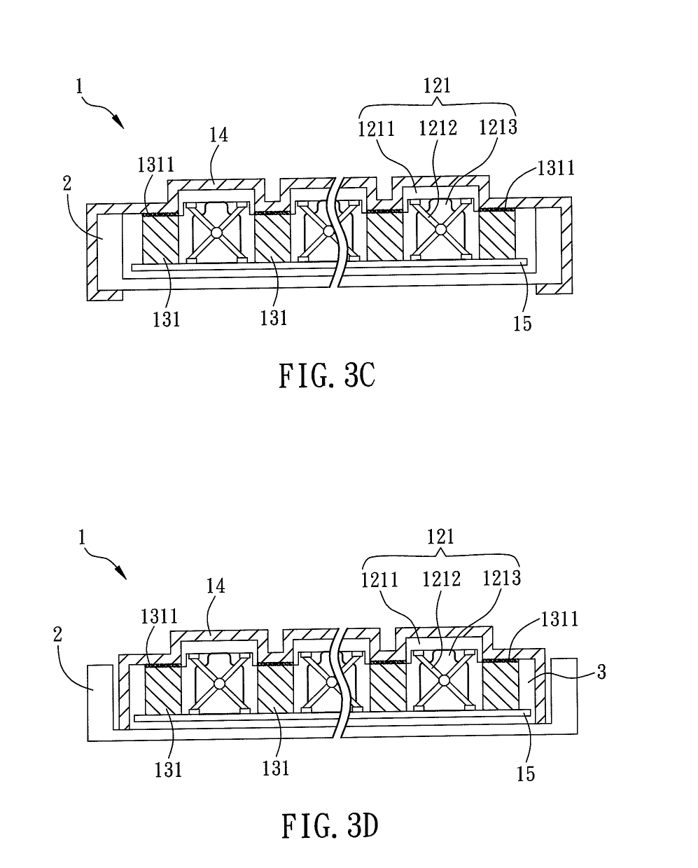

FIG. 1 is a schematic diagram showing a keyboard module according to a preferred embodiment of the disclosure, wherein the keyboard module is applied to a laptop computer, FIG. 2 is an exploded view of the keyboard module of FIG. 1, and FIG. 3A is a cross-sectional view of the keyboard module along the line A-A of FIG. 1. The structure and elements of the keyboard module of this disclosure will be described in advance in view of FIGS. 2 and 3, and the operation will be described later. Referring to FIG. 1, the keyboard module 1 is disposed on the casing 2 of the laptop computer B. Of course, the keyboard module 1 can also be configured on any other portable electronic device or integrated with a casing to function as an independent keyboard.

With reference to FIGS. 1 and 2, the keyboard module 1 includes a key unit 12, a fixed unit 13 and a cover layer 14. The key unit 12 includes a plurality of key structures 121. The fixed unit 13 includes a plurality of position limiting structures 131, which are respectively fixed to the key structures 121. The cover layer 14 covers and connects to the key unit 12 and the fixed unit 13. In order to make the drawings simple, only one row of key structures 121 is shown and the residual key structures 121 are omitted. The fixed unit 13 is a frame body containing a plurality of position limiting structures 131 and a plurality of holes 132. Each hole 132 receives one key structure 121. After assembling, the position limiting structures 131 are arranged one by one, and each position limiting structure 131 surrounds the corresponding key structure 121. Alternatively, FIGS. 3A to 3D are cross-sectional views of the keyboard module according to the preferred embodiment of the disclosure. Herein, for example, each key structure 121 is disposed in the corresponding position limiting structure 131.

Each key structure 121 includes a cap portion 1211, a support portion 1212 and a springy portion 1213. The support portion 1312 and the springy portion 1213 are individually connected to the cap portion 1211. The key structure 121 is not limited herein. For example, the springy portion 1213 can be a rubber cap, a spring cylinder, a scissor type structure, or any other structure that can provide the desired restoring force after the pressing. The support portion 1212 can be any structure that can increase the key strength. For example, the support portion 1212 can be a frame structure or a scissor type structure as shown in FIG. 2.

The material of the cover layer 14 can be any thermoplastic material such as plastic, rubber or silicone. The manufacturing method of the cover layer 14 is to inject the thermoplastic material into a mold and form the desired shape by thermo-pressing. Accordingly, it is possible to manufacture a plastic pad, a rubber pad, or a silicone pad stacked on the key unit 12. Of course, the material and manufacturing of the cover layer 14 are not limited to this example. After manufacturing the cover layer 14, it is disposed on the fixed unit 13 and the key unit 12. Since the cover layer 14 is integrally formed as one piece and is embedded into the casing 2 as shown in FIG. 1, it can function as a waterproof and opaque protective layer over the key unit 12. Thus, the cover layer 14 can prevent provide a seam-less surface to prevent objects or moisture from entering through the spaces between the key structures 121. Besides, the light is only allowed to pass through the opening or transparent portion on the cover layer 14, which can achieve the desired focused vision effect and have no light leakage.

The cover layer 14 can be fixed by the position limiting structure 131 or the key structure 121. To be noted, different fixing methods of the cover layer 14 provide different functions, which will be described hereinbelow.

As shown in FIG. 3A, the cover layer 14 is fixed by the position limiting structure 131 and the key structure 121. In practice, the fixed unit 13 is assembled with the key unit 12 and then fixed on a base plate 15, and the base plate 15 is fixed on the casing 2 (not shown). After that, the UV glue, thermo glue or any other glue is applied on the surface 1311 of the position limiting structure 131 or on a part of the cover layer 14 corresponding to the surface 1311 of the position limiting structure 131. After covering the cover layer 14 on the fixed unit 13 and the key unit 12, the cover layer 14 is cured by light, baking or any applicable method so as to adhere with the position limiting structure 131 of the fixed unit 13. Of course, their fixing method is not limited the above gluing and can be any applicable method such as adhering, locking or wedging. Compared with the conventional method of simply disposing the flexible protective pad, the cover layer 14 is fixed to the position limiting structure 131, so that the unintentional pressing of the adjacent key structure 12 while pressing the target one can be prevented (see FIG. 3B).

As shown in FIG. 3A, the cover layer 14 covers a part of the casing 2, and the casing 2 and the cover layer 14 form a closed space 3 for protecting the internal electronic components. Of course, the above function can be achieved by various approaches. As shown in FIG. 3C, the cover layer 14 includes larger size for covering and fixing on the casing 2 of the keyboard module 1. Alternatively, as shown in FIG. 3D, the cover layer 14 extends downwards to connect with the casing 2 and encapsulating the base plate 15. These two methods can also form a closed space 3 for protecting the internal electronic components so as to achieve the functions of dustproof and waterproof.

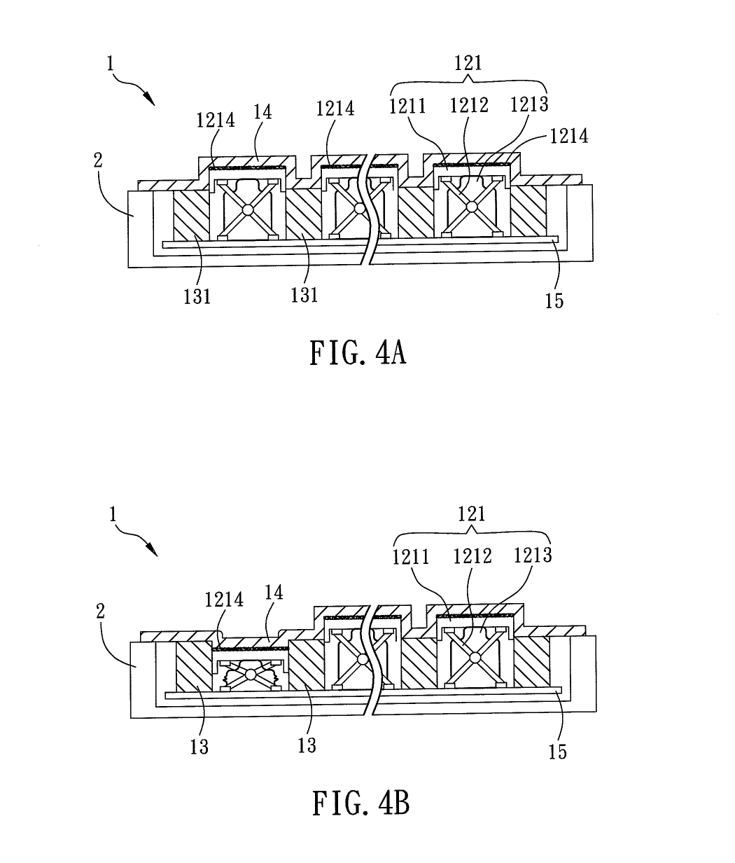

With reference to FIG. 4A, the UV glue, thermo glue or any other glue is applied on the surface 1214 of the key structure 121 (e.g. the entire or periphery of the surface 1214) or on a part of the cover layer 14 corresponding to the surface 1214 of the key structure 121. Similarly, the glue is cured by light, baking or any applicable method so as to adhere the cover layer 14 with the key unit 12. Of course, their fixing method is not limited the above gluing and can be any applicable method. As shown in FIG. 4B, this fixing method allows the key unit 12 to include larger moving range.

To be noted, the cover layer 14 can be alternately fixed with the position limiting structure 131 or the key structure 121. Thus, the improper appearance (e.g. protrusions of the cover layer 14 at two sides of the key structure 121) during a pressing event, that may occur as the cover layer 14 is fixed with both of the position limiting structure 131 and the key structure 121, can be prevented.

During the assembling of the conventional keyboard module, the key units must be inserted into the accommodating spaces of the frame body composed of the position limiting structures one by one. This assembling is time and labor consuming. In addition, since the rigidity of the elastic portion or support portion of the key unit is insufficient, the key unit is easily broken or damaged during the assembling.

The manufacturing process of the keyboard module of this disclosure can be modulated. In brief, the key unit and the cover layer are fixed at first, wherein the convex shape of the keys can be used in the positioning so as to quickly finish this fixing step. Next, since the relative position between the cover layer and the frame body composed by the position limiting structures is known, the key units can be assembled within the accommodating spaces of the frame body in a single process. This can efficiently reduce the assembling time and increase the product yield.

In summary, the keyboard module is configured with a cover layer or an elastic pad as a protective structure for providing the functions of waterproof and dustproof. Compared with the conventional art, which uses an additional protective pad to cover the keyboard, the cover layer of the disclosure can cover and fix the casing, so that the internal space of the keyboard is completely isolated from the exterior. Thus, the cover layer of the disclosure can provide better waterproof effect. Similarly, the disclosure can be applied to the illuminated keyboard. The complete closed structure can prevent the light leakage from the internal of the keyboard to the outside, thereby achieving the function of avoiding light leakage. Besides, the material of the cover layer makes the keyboard module of the disclosure more comfortable in use than the conventional keyboard. In addition, the cover layer is alternately connected with the frame body or the key unit, so that the improper appearance (e.g. protrusions of the cover layer at two sides of the key structure) during a pressing event can be prevented.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A keyboard module, comprising:
a key unit having a plurality of key structures;
a fixed unit having a plurality of position limiting structures, wherein the position limiting structures are fixed to the corresponding key structures, respectively; and
a cover layer covering and connecting to the key unit and the fixed unit.

2. The keyboard module of claim 1, wherein the cover layer and the fixed unit are fixed to each other.

3. The keyboard module of claim 1, wherein the cover layer is fixed to each of the key structures of the key unit.

4. The keyboard module of claim 1, wherein each of the key structures comprises a cap portion, a support portion and a springy portion, and the support portion and the springy portion are connected to the cap portion respectively.

5. The keyboard module of claim 1, wherein the fixed unit is a frame body.

6. The keyboard module of claim 1, wherein the cover layer comprises a rubber pad, a silicone pad, or a plastic pad.

7. The keyboard module of claim 1, wherein the keyboard module is accommodated in a casing, and the cover layer covers a part of the casing.

8. The keyboard module of claim 1, wherein the keyboard module is accommodated in a casing, and the cover layer and the casing form a closed space.
